(19) United States
(12) Patent Application Publication
(10) Pub. No.: US 2021/0003986 A1
(43) Pub. Date: Jan. 7, 2021

(54) SYSTEM CONSTRUCTION SUPPORT DEVICE, SYSTEM CONSTRUCTION SUPPORT METHOD, AND STORAGE MEDIUM THEREFOR

(71) Applicant: Mitsubishi Electric Corporation, Tokyo (JP)

(72) Inventor: Koji NISHIUCHI, Tokyo (JP)

(73) Assignee: Mitsubishi Electric Corporation, Tokyo (JP)

(21) Appl. No.: 16/464,694

(22) PCT Filed: Apr. 6, 2018
(86) PCT No.: PCT/JP2018/014758

§ 371 Date: May 29, 2019

(51) Int. Cl. G05B 19/05; G06F 3/048; G06F 3/0354

(52) U.S. Cl. CPC G05B 19/05; G05B 2219/15078; G06F 3/03543; G06F 3/048

(57) ABSTRACT

A system construction support device includes: an operation receiving unit that receives an operation of a user; and a display control unit that displays, on a display unit, a screen for supporting construction work of a system constructed of a plurality of units, based on a content of the operation received by the operation receiving unit. When the operation receiving unit receives a predetermined specific operation, the display control unit displays, on the display unit, a unit specification image representing a specification of each of the units constituting the system in a graphic form, in association with a unit image that is an image representing a unit.

### FIELD

The present invention relates to a system construction support device, a system construction support method, and a system construction support program that support construction of a system composed of a plurality of units.

### BACKGROUND

A programmable logic controller (hereinafter, referred to as a PLC) system is constructed by combining two or more units. That is, a user of the PLC system selects necessary units from two or more types of units, and combines the selected units to construct the PLC system. Patent Literature 1 describes a PLC system construction support tool that supports construction work of a PLC system.

The PLC system construction support tool described in Patent Literature 1 has a function of calculating total values of specifications such as the width, the weight, and the current consumption of each of units constituting the PLC system and displaying the total values on a screen each time the user selects a unit. The PLC system construction support tool described in Patent Literature 1 also has a function of displaying the units constituting the PLC system in box graphics and displaying information on the units in a text format.

### CITATION LIST

### Patent Literature

Patent Literature 1: Japanese Patent Application Laid-open No. 2002-108421

### SUMMARY

### Technical Problem

The inventive technique described in Patent Literature 1 displays all units in equal box forms regardless of the types of the units, and displays information sets on the units in a text format in their respective box forms. For that reason, to know the types of the units, it is necessary to refer to the information sets displayed in the box forms imitating the units, and so if the number of units increases, it takes much time to grasp the information sets on the units. This has led to some problem. For example, in a case where communication with another device becomes unnecessary, there is a possibility that it takes much time to find a unit to be removed in spite of a situation that the user wants to remove a unit having a function of such communication. The units constituting the PLC system include many types, such as an input unit, an output unit, a network unit for communicating with other systems via a network, a CPU (central processing unit) unit that controls each unit, and a power supply unit that supplies electric power to each unit. In addition, the input unit includes several types, such as an input unit for inputting an analog signal, and an input unit for inputting a digital signal. Further, there are input units and output units with different numbers of signals that can be handled at the same time. When information on these various types of units is displayed using textual information, an amount of information increases, and a user's load is increased of work for confirming differences between the units from the textual information.

The present invention has been made in view of the above circumstances, and its object is to provide a system construction support device that enables a user to easily grasp specifications of the units constituting a system composed of two or more units.

### Solution to Problem

In order to solve the problems described above and achieve the object, a system construction support device according to the present invention comprises: an operation receiving unit to receive an operation of a user; and a display control unit to display, on a display unit, a screen for supporting construction work of a system constructed of a plurality of units, based on a content of the operation received by the operation receiving unit. When the operation receiving unit receives a predetermined specific operation, the display control unit displays, on the display unit, a unit specification image representing a specification of each of the units constituting the system in a graphic form, in association with a unit image that is an image representing a unit.

### Advantageous Effects of Invention

The system construction support device according to the present invention has an advantageous effect that the user can easily grasp the specifications of units constituting the system composed of two or more units.

### BRIEF DESCRIPTION OF DRAWINGS

FIG. 1 is a diagram illustrating a configuration example of a system construction support device according to an embodiment of the present invention.

FIG. 2 a diagram illustrating a configuration example of hardware by which the system construction support device according to the embodiment can be implemented.

FIG. 3 a flowchart illustrating an operation of displaying a PLC system editing screen display information on a display unit by the system construction support device according to the embodiment.

FIG. 4 is a diagram illustrating an example of specification images represented by various kinds of image data held by a specification information holding unit of the system construction support device according to the embodiment.

FIG. 5 is a flowchart illustrating an operation of displaying a unit list display information on the display unit by the system construction support device according to the embodiment.

FIG. 6 is a diagram illustrating an example of a screen displayed in a PLC system editing area by the system construction support device according to the embodiment.

FIG. 7 is a diagram illustrating an example of a screen displayed in a case where the system construction support device according to the embodiment receives an operation of designating one of unit specification images from a user.

FIG. 8 is a diagram illustrating a modification of specification information held by the system construction support device according to the embodiment.

FIG. 9 is a flowchart illustrating an example of an operation of displaying an explanation of a specification in a case where the system construction support device according to the embodiment detects that a mouse pointer is positioned on the unit specification image.

### DESCRIPTION OF EMBODIMENTS

Hereinafter, a system construction support device, a system construction support method, and a system construction support program according to an embodiment of the present invention will be described in detail with reference to the drawings. Incidentally, the invention is not necessarily limited by the embodiment. In addition, in the following description, a specification means a type of a signal handled by a unit that is a device constituting a PLC system, a direction of the signal handled by the unit, the number of signals that can be handled by the unit at the same time, a capacity of a power supply that can be supplied by the unit to another unit, and an amount of current caused when the unit operates (hereinafter referred to as “current consumption of a unit”). The type of the signal means any of a digital signal in which an ON or OFF state continues, an analog signal, a pulse signal, and a signal conforming to a communication protocol, and the direction of the signal means either an input signal or an output signal. It is noted that the specifications described above are enumerated as specifications used in the description of the embodiment, but types of specifications that can be handled by the system construction support device are not limited to these mentioned specifications.

### Embodiment

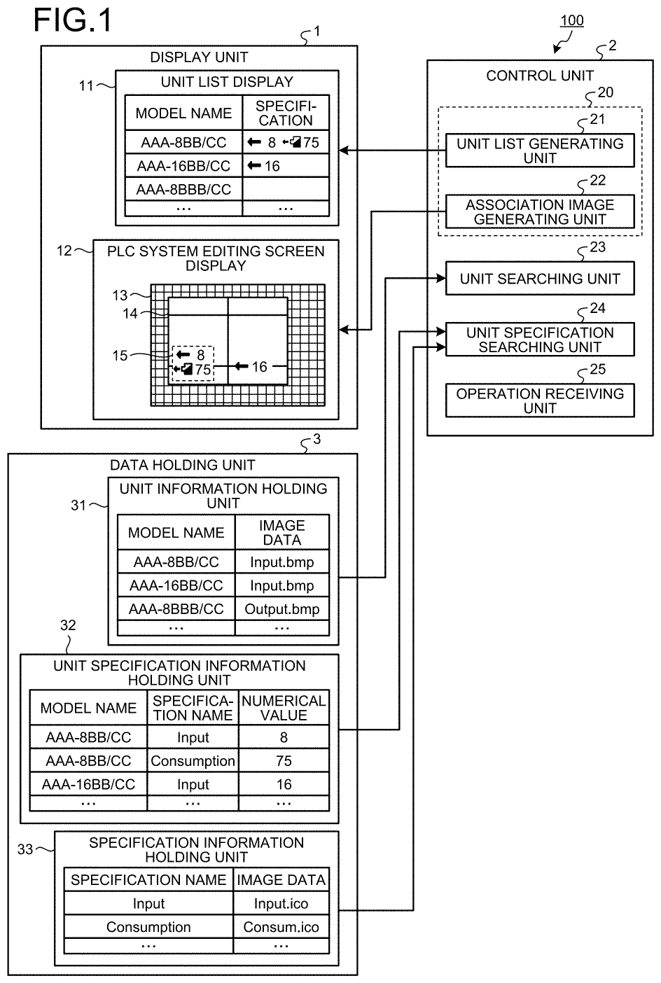

FIG. 1 is a diagram illustrating a configuration example of the system construction support device according to the embodiment of the present invention. A system construction support device 100 according to the present embodiment includes a display unit 1, a control unit 2, and a data holding unit 3.

The display unit 1 displays a screen for supporting work of a user constructing a PLC system, in accordance with an instruction of the control unit 2. Examples of the screen displayed by the display unit 1 include a unit list display 11 and a PLC system editing screen display 12 illustrated in FIG. 1. Another screen other than the unit list display 11 and the PLC system editing screen display 12 is also displayed on the display unit 1 as appropriate.

The control unit 2 includes a unit list generating unit 21, an association image generating unit 22, a unit searching unit 23, a unit specification searching unit 24, and an operation receiving unit 25. The unit list generating unit 21 generates a screen to be displayed as the unit list display 11, based on data held in the data holding unit 3, and displays the screen generated on the display unit 1. The association image generating unit 22 generates an image to be displayed in association with each of units constituting the PLC system in the PLC system editing screen display 12, based on the data held in the data holding unit 3, and generates a screen to be displayed as the PLC system editing screen display 12 using the generated image. The association image generating unit 22 displays the generated screen on the display unit 1. The unit searching unit 23 executes search processing on the data held by the data holding unit 3 to acquire data of an image representing a unit, necessary for generating the unit list display 11 and the PLC system editing screen display 12. The unit specification searching unit 24 executes search processing on the data held by the data holding unit 3 to acquire information on the specifications of the unit necessary for generating the unit list display 11 and the PLC system editing screen display 12. The operation receiving unit 25 receives an operation of the user.

In the control unit 2 having such a configuration, when the operation receiving unit 25 receives a predetermined specific operation, the unit list generating unit 21 and the association image generating unit 22 execute the operation described above to display the unit list display 11 and the PLC system editing screen display 12 on the display unit 1. The predetermined specific operation is an operation of giving an instruction to start editing the PLC system, and includes, for example, an operation of selecting a new construction of the PLC system on a menu screen displayed on the display unit 1, an operation of selecting a modification of the PLC system already constructed on the menu screen, and the like. Here, the unit list display 11 and the PLC system editing screen display 12 are screens for supporting user's construction work of the PLC system. The unit list generating unit 21 and the association image generating unit 22 serve as a display control unit 20 that displays, on the display unit 1, the screens for supporting the construction work of the PLC system, based on the operation received by the operation receiving unit 25.

The data holding unit 3 includes a unit information holding unit 31, a unit specification information holding unit 32, and a specification information holding unit 33. The unit information holding unit 31 holds data (image data in FIG. 1) of a unit image that is an image schematically representing each unit that can be used for construction of the PLC in association with a model name that is a name of each unit. The unit specification information holding unit 32 holds information on the specifications of each unit that can be used for construction of the PLC in association with the model name of each unit. The information on the specifications of a unit is “specification name” and “numerical value”. In the example illustrated in FIG. 1, a specification name “Input” represents a digital input, and “numerical value” associated with “Input” means the number of signals that can be handled by the unit. A specification name “Consumption” means a current consumption of the unit. The specification information holding unit 33 holds data (image data in FIG. 1) of a specification image that is an image representing each specification, in association with a specification name.

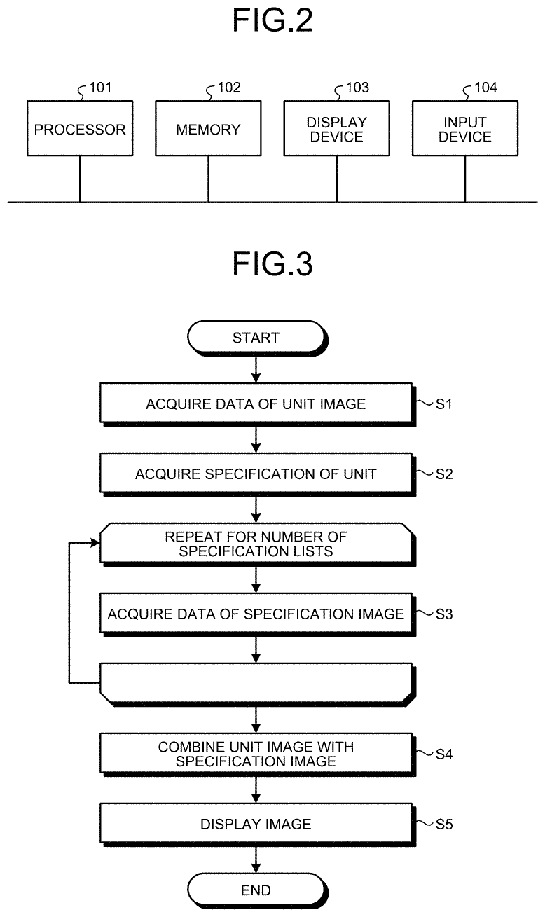

FIG. 2 is a diagram illustrating a configuration example of hardware by which the system construction support device 100 according to the present embodiment can be realized. The hardware illustrated in FIG. 2 is, for example, a personal computer, and includes a processor 101, a memory 102, a display device 103, and an input device 104. The processor 101 is a CPU, and is also called a central processing device, a processing device, an arithmetic device, a microprocessor, a microcomputer, or a digital signal processor (DSP). The memory 102 is a nonvolatile or volatile semiconductor memory, such as a random access memory (RAM), a read only memory (ROM), a flash memory, an erasable programmable read only memory (EPROM), or an electrically erasable programmable read only memory (EEPROM) (registered trademark), a magnetic disk, a flexible disk, an optical disk, a compact disk, a mini disk, a digital versatile disk (DVD), or the like. The display device 103 is a liquid crystal monitor, a display, or the like. The input device 104 is a keyboard, a mouse, or the like.

The display unit 1 of the system construction support device 100 is implemented by the display device 103. The control unit 2 of the system construction support device 100 is implemented by the processor 101 and the memory 102. That is, the unit list generating unit 21, the association image generating unit 22, the unit searching unit 23, the unit specification searching unit 24, and the operation receiving unit 25 of the control unit 2 are implemented by the processor 101 reading a program for implementing functions of these units from the memory 102 and executing the program, the program being held by the memory 102 in advance. The data holding unit 3 of the system construction support device 100 is implemented by the memory 102. Incidentally, the input device 104 is used when the user performs various kinds of operations on the system construction support device 100. The operation performed on the system construction support device 100 by the user using the input device 104 is received by the operation receiving unit 25 of the control unit 2.

Next, an operation of the system construction support device 100 will be described with reference to FIG. 1 and FIGS. 3 to 9.

FIG. 3 is a flowchart illustrating an operation of displaying the PLC system editing screen display 12 on the display unit 1 by the system construction support device 100. When the user performs an operation of adding a unit for constructing the PLC system, the system construction support device 100 starts the operation according to FIG. 3. In a case where the unit is added to the PLC system, the user selects the unit to be added from units described in the unit list display 11, and places the selected unit in a PLC system editing area 13 in the PLC system editing screen display 12. For example, the user selects a unit to be added by designating a specific row of the unit list display 11 with the mouse, and places the selected unit in the PLC system editing area 13 by drag and drop. Along with this, the system construction support device 100 starts the operation according to FIG. 3.

When the operation of placing the unit in the PLC system editing area 13, that is, the operation of adding the unit is performed, the control unit 2 acquires, from the data holding unit 3, information necessary for displaying, in the PLC system editing area 13, an image obtained by combining a unit image 14 representing the added unit and a unit specification image 15 representing the specifications of the added unit. This processing corresponds to steps S1 to S3 of FIG. 3. Specifically, first, the unit searching unit 23 of the control unit 2 searches the unit information holding unit 31 using a model name of the unit selected by the user (here, “AAA-8BB/CC” is selected as an example) as a key, and acquires data of a unit image imitating the unit of AAA-8BB/CC (“Input.bmp” in the case of “AAA-8BB/CC”) (step S1).

Next, the unit specification searching unit 24 acquires the specifications of the unit selected by the user (step S2). In this step S2, the unit specification searching unit 24 searches the unit specification information holding unit 32 using the model name (AAA-8BB/CC) of the above-mentioned unit selected by the user as a key, and acquires a list of a specification name and a numerical value of its specification associated with the model name AAA-8BB/CC of the unit. In the example illustrated in FIG. 1, the unit specification searching unit 24 acquires “Input” and “8”, and “Consumption” and “75”, which are associated with AAA-8BB/CC.

Next, the control unit 2 performs processing indicated in step S3 repeatedly for the number of specification lists acquired, that is, the number of lists each consisting of a specification name and a numerical value of its specification acquired in step S2.

In the case of the unit of AAA-8BB/CC, since two lists including a set of “Input” and “8”, and another set of “Consumption” and “75” are acquired in step S2, the control unit 2 repeats the processing of step S3 twice.

In step S3, the unit specification searching unit 24 searches the specification information holding unit 33 using one of the specification names acquired in step S2 as a key, and acquires data of a specification image corresponding to the specification name. For example, the unit specification searching unit 24 acquires “Input.ico” in a case where the search key is “Input”. In a case where two lists of “Input” and “8”, and “Consumption” and “75” are acquired in step S2, the unit specification searching unit 24 acquires the specification image “Input.ico” corresponding to the specification “Input” in the first step S3, and acquires the specification image “Consum.ico” corresponding to the specification “Consumption” in the second step S3.

Next, the control unit 2 combines the unit image represented by the data acquired in step S1 with each specification image represented by each data set acquired in step S3 to generate an image for display (step S4), and displays the generated image in the PLC system editing area 13 of the PLC system editing screen display 12 (step S5). In step S4, the control unit 2 first generates a unit specification image based on the data acquired in step S3 and the numerical value of the specification acquired in step S2. Specifically, the control unit 2 generates the unit specification image by converting the numerical value of the specification into an image and combining this image with the specification image represented by the data acquired in step S3. Next, the control unit combines the unit generated specification image with the unit image to generate an image for display. In a case where the unit selected by the user is AAA-8BB/CC, the control unit 2 generates the unit specification image 15 illustrated in FIG. 1 and combines this unit specification image 15 with the unit image 14 to thereby generate the image for display. The processing of these steps S4 and S5 is performed by the association image generating unit 22. In step S5, the association image generating unit 22 displays the image at a position designated by the user's operation described above (operation using drag and drop or the like) or a position derived based on the designated position.

According to the method described above, the system construction support device 100 can display an association image that is an image in which the unit image 14 representing the unit selected by the user is combined with the unit specification image 15, in the PLC system editing area 13. FIG. 1 illustrates an example in which the unit specification image 15 is superimposed on the unit image 14, but the unit specification image 15 may be displayed adjacent to the unit image 14 in such a manner that the unit specification image 15 is set in line below the unit image 14, for example. Any display format may be used as long as the display is in a form such that one can understand that the unit image 14 and the unit specification image 15 are associated with each other. In addition, for example, a unit that can input a digital signal is generally prepared to have a separate setting screen with which a sampling interval and the like can be set. For that reason, in a case where the user performs an operation of double-clicking the unit specification image 15 (that is an image representing a digital input in this example) in the PLC system editing area 13, the system construction support device 100 may make a transition to a setting screen for the sampling interval.

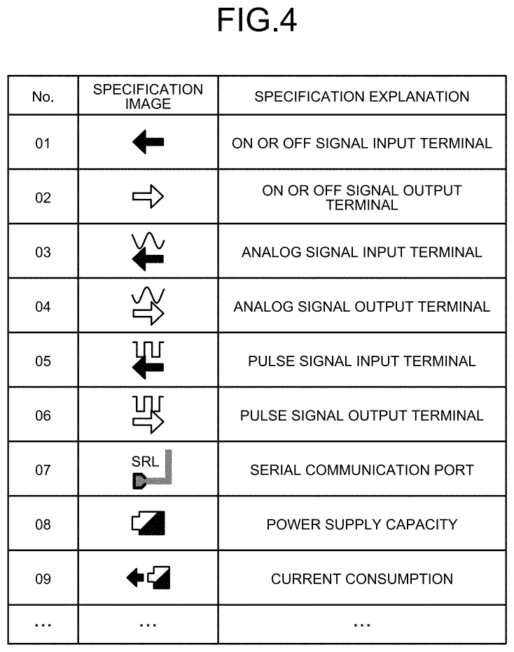

FIG. 4 is a diagram illustrating an example of the specification images represented by various kinds of data held by the specification information holding unit 33. The specification information holding unit 33 holds data indicating the various specification images illustrated in FIG. 4. The system construction support device 100 generates the unit specification image 15 illustrated in FIG. 1 by using one or by combining two or more of the specification images illustrated in FIG. 4, and displays the unit specification image 15 in the PLC system editing area 13 in association with a single unit image. By so doing, the system construction support device 100 can represent the specifications of one unit as an image. As a result, the user can intuitively know the specifications of the unit from the specification image associated with the unit image. In FIG. 4, an example of nine specification images numbered 01 to 09 are illustrated, but the specification information holding unit 33 may hold data of specification images other than these nine images. In addition, a content of the specification image may be anything as long as the specification of the unit can be known from the image. Besides, it is preferable that these specification images are defined in advance in accordance with a standard or the like, and defined ones are used. If the image is defined by the standard or the like, it is easy to grasp the specifications of the unit on the PLC system editing screen display 12 regardless of who is a user using the function.

Here, as illustrated in FIG. 1, the same image as the specification image represented by the various kinds of data held by the specification information holding unit 33 may be displayed on the unit list display 11. That is, the specifications may be indicated by images. In this way, the specifications of the unit described in the unit list display 11 can be intuitively known. Work can therefore be easy of searching for the unit of specifications desired by the user from the units described in the unit list display 11. This leads to an advantage in that a burden can be reduced on PLC system editing work that is work for constructing the PLC system.

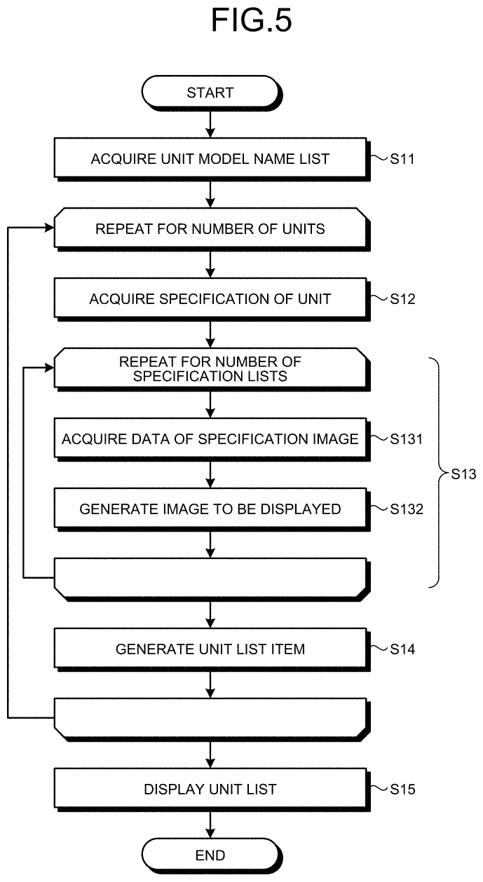

FIG. 5 is a flowchart illustrating an operation of displaying the unit list display 11 on the display unit 1 by the system construction support device 100. When an operation of starting construction of the PLC system is performed by the user, the system construction support device 100 starts the operation according to FIG. 5.

In a case where the system construction support device 100 displays the unit list display 11 on the display unit 1, first, the unit list generating unit 21 of the control unit 2 requests information on model names of all the units that can be used in construction of the PLC from the unit searching unit 23, and the unit searching unit 23 acquires a unit model name list that is a list of model names of all the units existing in the unit information holding unit 31 (step S11).

Next, the control unit 2 repeats processing indicated in steps S12 to S14 for the number of units acquired, that is, the number of model names of the units included in the unit model name list acquired in step S11.

In step S12, the unit specification searching unit 24 selects a model name of one unit in the unit model name list acquired in step S11, searches the unit specification information holding unit 32 with the model name as a key, and acquires a list of a specification name and a numerical value of the specification, corresponding to the unit model name used as the key. The processing of this step S12 is similar to the processing of step S2 of FIG. 3 described above. In step S12 repeatedly executed, when selecting the model name of the unit as the search key, the unit specification searching unit 24 selects a model name of a unit that has not been selected in the past.

In step S13 executed subsequently to step S12, the control unit 2 repeats processing indicated in steps S131 and S132 for the number of specification lists acquired, that is, the number of lists consisting of a specification name and a numerical value of the specification, acquired in step S12.

In step S131, the unit specification searching unit 24 searches the specification information holding unit 33 using one of the specification names acquired in step S12 as a key, and acquires data of the specification image corresponding to the specification name. The processing of this step S131 is similar to the processing of step S3 of FIG. 3 described above.

In the next step S132, the unit specification searching unit 24 combines the specification image represented by the data acquired in step S131 with an image obtained by imaging “numerical value” of the specification corresponding to the specification name used as the key in step S131 among “numerical values” of the specifications acquired in step S12, to generate an image to be displayed on the unit list display 11 (step S132). In step S131 repeatedly executed, when selecting the specification name as the search key, the unit specification searching unit 24 selects a specification name that has not been selected in the past.

In step S14, the unit list generating unit 21 generates a unit list item that is one item included in the unit list display using the unit model name list acquired in step S11 and the image generated in combining processing in step S132. The unit list item is a model name and a specification displayed on one row of the unit list display 11 illustrated in FIG. 1.

Upon completion of repetitive processing indicated in steps S12 to S14, the unit list generating unit 21 generates a unit list by arranging a plurality of the unit list items generated in step S14 repeatedly executed, and displays the unit list as the unit list display 11 (step S15).

With the method described above, the specification image of the unit can be displayed on the unit list display 11 and the PLC system editing screen display 12. Here, in order to support work of a user searching for units with the same specifications, a configuration may be used in which a user can select whether to display the specification image of each unit or not to display. That is, the system construction support device 100 provides the user with an environment that makes work easier by enabling the user to select a display format in accordance with the user's preference.

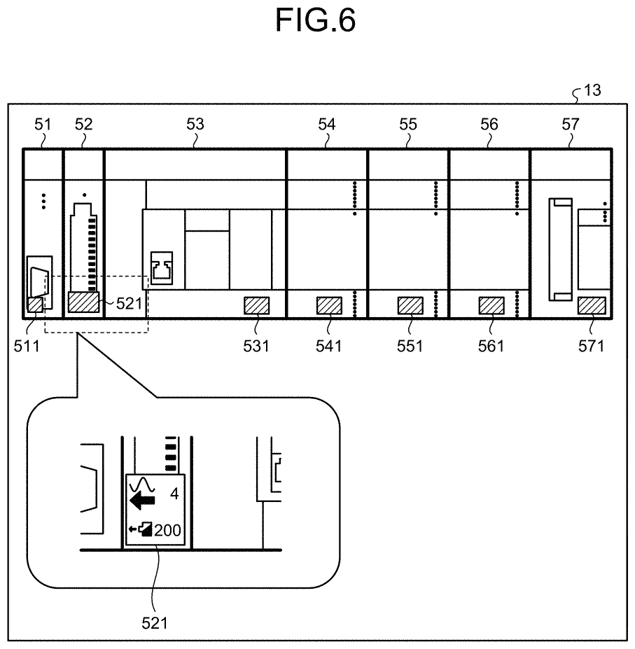

FIG. 6 is a diagram illustrating an example of a screen displayed in the PLC system editing area 13 by the system construction support device 100. The display example illustrated in FIG. 6 is an example in a case where seven units are selected by the user and arranged in the PLC system editing area 13, whereby unit images 51 to 57 are displayed together with the unit specification images. Specifically, a unit specification image 511 is displayed to overlap the unit image 51, a unit specification image 521 is displayed to overlap the unit image 52, and a unit specification image 531 is displayed to overlap the unit image 53. In addition, a unit specification image 541 is displayed to overlap the unit image 54, a unit specification image 551 is displayed to overlap the unit image 55, a unit specification image 561 is displayed to overlap the unit image 56, and a unit specification image 571 is displayed to overlap the unit image 57. In FIG. 6, for explanation, the unit specification image 521 associated with the unit image 52 is illustrated to be enlarged. The unit specification image 521 of the example illustrated in FIG. 6 represents that the unit indicated by the unit image 52 has four analog signal input terminals and current consumption is 200 mA. As illustrated in FIG. 6, the unit specification image 521 represents the specifications of the unit indicated by the unit image 52 in a graphic form The same also applies to unit specification images associated with the other units. Accordingly, the system construction support device 100 enables the user to intuitively conceive the specifications of the unit from the graphic form represented by the unit specification image, and the user can easily grasp the specifications of each unit. In addition, the unit images 51 to 57 have designs imitating the respective units such that the types of the respective units can be visually discriminated. Therefore, the system construction support device 100 enables the user to easily grasp the types of the units from the unit images.

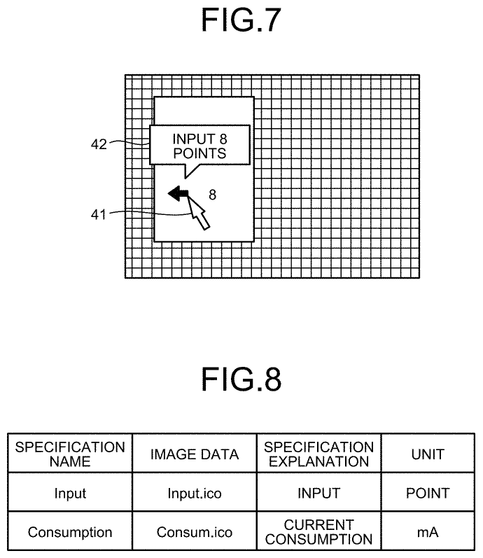

To make it easier to grasp the specifications of the unit, for example, in a case where the user performs an operation of designating one of the unit specification images currently being displayed in the PLC system editing area 13, the system construction support device 100 may display a specification explanation display corresponding to the designated unit specification image. The user designates a unit specification image by, for example, performing an operation of situating a mouse pointer on the unit specification image. That is, in a case where the user performs an operation of situating the mouse pointer on the unit specification image, the system construction support device 100 displays the specification explanation corresponding to the unit specification image pointed by the mouse pointer. A screen display example at this time is illustrated in FIG. 7. FIG. 7 is a diagram illustrating an example of a screen displayed in a case where the system construction support device 100 receives an operation of designating one of the unit specification images from the user. As illustrated in FIG. 7, when detecting that a mouse pointer 41 is positioned on a unit specification image, the system construction support device 100 displays a specification explanation display 42 corresponding to the unit specification image pointed by the mouse pointer 41, in the PLC system editing area 13. In this case, the specification information holding unit 33 illustrated in FIG. 1 holds the specification information of a configuration illustrated in FIG. 8. FIG. 8 is a diagram illustrating a modification of the specification information held by the system construction support device 100. The specification information illustrated in FIG. 8 is constructed to include “specification explanation” and “unit” in addition to “specification name” and “image data” illustrated in FIG. 1. The “specification explanation” is an explanation of what a specification represented by the “specification name” is. “Unit” is a unit of a “numerical value” of the specification in the information held by the unit specification information holding unit 32.

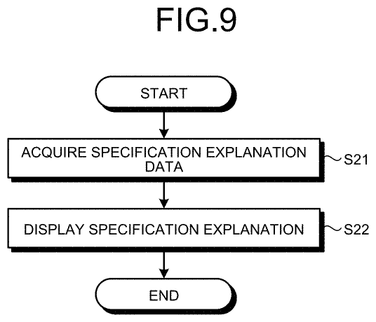

FIG. 9 is a flowchart illustrating an operation of the system construction support device 100 displaying the specification explanation in a case where the system construction support device 100 detects that the mouse pointer is positioned on the unit specification image.

When detecting that the mouse pointer is positioned on the unit specification image displayed in the PLC system editing area 13, the control unit 2 of the system construction support device 100 searches the specification information holding unit 33 using the specification name of the specification image constituting the unit specification image corresponding to the position of the mouse pointer as a key, and acquires the specification explanation and the unit as specification explanation data (step S21). Next, based on the acquired explanation data and a “numerical value” associated with the specification name of the specification image corresponding to the position of the mouse pointer, the control unit 2 generates and displays the specification explanation display 42 illustrated in FIG. 7 (step S22). The processing of steps S21 and S22 is performed by the association image generating unit 22.

In this way, even in a case where the specifications expressed by the unit specification image is no longer known, the contents of the specifications can be easily confirmed. Incidentally, an example has been described in a case where the unit specification image includes one specification image, that is, a case where the unit specification image is generated by using one of the data sets held in the specification information holding unit 33, but in a case where the unit specification image is constructed to include plural specification images, the specification explanation display may be displayed for one specification image corresponding to the position of the mouse pointer, or the specification explanation display may be displayed for all the specification images constructed of the unit specification image. In a case where the unit specification image corresponding to the position of the mouse pointer is constructed of the plural specification images and the specification explanation display is performed for all the specification images, the control unit 2 repeatedly searches the specification information holding unit 33 using specification names of the plural specification images constructed of the unit specification image as keys in step S21 described above, and acquires the explanation data set corresponding to each of the specification names. Then, in step S22 described above, the control unit 2 generates and displays the specification explanation display based on the plural explanation data sets.

As described above, the system construction support device 100 according to the present embodiment holds the data of the unit images representing the units that can be incorporated in the PLC system, and the data of the specification images representing the specification of the units, and in the case of displaying the unit image corresponding to the unit selected by the user, displays the unit image in association with the specification image representing the specification of the selected unit. By doing so, the user can be informed of the specification of the unit corresponding to the unit image displayed, using the specification image. That is, the user can know the specification of the unit from the specification image. The system construction support device can therefore be implemented that enables the user to easily confirm the specifications of the units constituting the PLC system.

In the embodiment described above, an example has been described in which the user uses the system construction support device 100, and selects a unit from units displayed in the unit list display 11 to add the unit to the PLC system, but this is not a limitation to the invention. The system construction support device 100 has a function of correcting data of a PLC system already constructed in the past, a function of newly constructing a PLC system using the data of the PLC system already constructed in the past, and the like. Also in a case where the user uses these functions, the system construction support device 100 displays unit images representing units constituting the PLC system already constructed in the past and unit specification images representing the specifications of the units in association with each other, in the PLC system editing area 13. In this case, when receiving an operation of giving an instruction to start using the function of using the data of the PLC system already constructed in the past, the system construction support device 100 displays a display similar to the PLC system editing screen display 12 illustrated in FIG. 1, on the display unit 1.

Incidentally, in the embodiment described above, the unit specification image is displayed in association with the unit image that is the image imitating the unit, for all the units constituting the PLC system, but the unit specification image may be displayed for some of the units. For example, for the units whose specification can be easily conceived from the unit image, such as the network unit and the CPU unit, it is not necessary to display the unit specification image in association with the unit image.

In addition, in the embodiment described above, an example has been described of a system construction support device that supports system construction of the PLC system, but the invention is not limited to this example. The system construction support device according to the present invention can support construction of a system as long as the system is a system constructed of two or more units. For example, the system construction support device according to the present invention can also be applied to a case of supporting construction of a servo system composed of a motor, an amplifier, a controller, and so on. In this case, the motor, the amplifier, the controller, and so on correspond to the units described above.

The configuration described in the above embodiment shows an example of contents of the present invention, and can be combined with other publicly known techniques and partially omitted and/or modified without departing from the scope of the present invention.

### REFERENCE SIGNS LIST

1 display unit; 2 control unit; 3 data holding unit; 11 unit list display; 12 PLC system editing screen display; 13 PLC system editing area; 14, 51 to 57 unit image; 15, 511, 521, 531, 541, 551, 561, 571 unit specification image; 20 display control unit; 21 unit list generating unit; 22 association image generating unit; 23 unit searching unit; 24 unit specification searching unit; 25 operation receiving unit; 31 unit information holding unit; 32 unit specification information holding unit; 33 specification information holding unit; 41 mouse pointer; 42 specification explanation display; 100 system construction support device.

1. A system construction support device comprising:
operation receiving circuitry to receive an operation of a user; and
display control circuitry to display, on a display, a screen for supporting construction work of a system constructed of a plurality of units, based on a content of the operation received by the operation receiving circuitry, wherein
when the operation receiving circuitry receives a predetermined specific operation, the display control circuitry displays, on the display, a unit specification image representing a specification of each of the units constituting the system in a graphic form, in association with a unit image that is an image representing a unit.

2. The system construction support, device according to claim 1, wherein
the display control circuitry displays, on the display, the unit specification image in a state of being superimposed on the unit image or in a state of being adjacent to the unit image.

3. The system construction support device according to claim 1, wherein
when the operation receiving circuitry receives an operation of designating the unit specification image being displayed on the display, the display control circuitry displays, on the display, contents of the specifications represented by the unit specification image designated by the operation received by the operation receiving circuitry.

4. The system construction support, device according to claim 1, wherein
the specifications represented by the unit specification image include a type and a direction of a signal handled by the unit, the number of signals that can be handled by the unit, a capacity of a power supply that can be supplied by the unit to another unit, and a current consumption of the unit.

5. The system construction support device according to claim 1, comprising:
a unit information holding memory to hold a plurality of types of the unit images;
a specification information holding memory to hold a plurality of types of specification images each representing one of the specifications of the unit;
operation receiving circuitry to receive an operation performed by a user;
unit searching circuitry to acquire, from the unit information holding memory, a unit image representing the unit selected by the unit selecting operation when the operation receiving circuitry receives the unit selecting operation that is an operation of selecting the unit; and
unit specification searching circuitry to acquire, from the specification information holding memory, the specification images corresponding to the specifications of the unit selected by the unit selecting operation received by the operation receiving circuitry,
wherein the display control circuitry combines the specification images acquired by the unit specification searching circuitry to generate the unit specification image, and combines the generated unit specification image with the unit image acquired by the unit searching circuitry to display a combination result on a screen for supporting the construction work,

6. The system construction support device according to claim 5, wherein
the display control circuitry displays a list of selectable units together with the unit specification images on the display when the operation receiving circuitry receives the unit selecting operation.

7. A system construction support method executed by a system construction support device that supports construction work of a system constructed of a plurality of units, the system construction support method comprising:
receiving an operation of giving an instruction to start construction work of the system; and
displaying, on a display, a unit specification image representing a specification of the unit constituting the system in a graphic form, in association with a unit image that is an image representing the unit.

8. The system construction support method according to claim 7, further comprising:
receiving an image designation operation that is an operation of designating the unit specification image being displayed on the display; and
displaying, on the display, a content of the specification represented by the unit specification image designated by the received image designation operation.

9. The system construction support method according to claim 7, further comprising:
receiving a unit selecting operation that is an operation of selecting the unit;
acquiring a unit image representing a unit selected by the received unit selecting operation from a unit information holding memory to hold a plurality of types of the unit images;
acquiring a specification image corresponding to a specification of the unit selected by the received unit selecting operation from a specification information holding memory to hold a plurality of types of specification images each representing one of the specifications of a unit;
combining the acquired specification images to generate specification image; and
combining the generated unit specification image with the acquired unit image to display a combination result on a screen for supporting the construction work.

10. The system construction support method according to claim 9, wherein
in the receiving the unit selecting operation, a list of selectable units is displayed together with the unit specification images on the display.

11. A system construction support program causing a computer to execute:
receiving an operation of giving an instruction to start construction work of a system constructed of a plurality of units; and
displaying, on a display, a unit specification image representing a specification of each of the units constituting the system in a graphic form, in association with a unit image that is an image representing the unit.

12. The program according to claim 11, the system construction support program causing the computer to execute:
receiving an image designation operation that is an operation of designating the unit specification image being displayed on the display; and
displaying, on the display, a content of the specification represented by the unit specification image designated by the received image designation operation.

13. The program according to claim 11, the system construction support program causing the computer to execute:
receiving a unit selecting operation that is an operation of selecting the unit;
acquiring a unit image representing a unit selected by the received unit selecting operation from a unit information holding memory to hold a plurality of types of the unit images;
acquiring a specification image corresponding to a specification of the unit selected by the received unit selecting operation from a specification information holding memory to hold a plurality of types of the specification images each representing one of the specifications of a unit;
combining the acquired specification images to generate the unit specification image; and
combining the generated unit specification image with the acquired unit image to display a combination result on a screen for supporting the construction work.

14. The program according to claim 13, wherein
in the receiving the unit selecting operation, a list of selectable units is displayed together with the unit specification images on the display.
